(19) United States
(12) Patent Application Publication
(10) Pub. No.: US 2018/0362898 A1
(43) Pub. Date: Dec. 20, 2018

(54) Stainless Steel, Glass, Wood and Stone Polish and Protectant

(71) Applicant: Gregg A. Motsenbocker, San Diego, CA (US)

(72) Inventor: Gregg A. Motsenbocker, San Diego, CA (US)

(21) Appl. No.: 15/007,107

(22) Filed: Jan. 26, 2016

(51) Int. Cl. C11D 7/24; C11D 7/32; C11D 7/26; C11D 11/00

(52) U.S. Cl. CPC C11D 7/24; C11D 7/248; C11D 7/242; C11D 11/0035; C11D 7/267; C11D 7/268; C11D 11/0029; C11D 7/3218

(57) ABSTRACT

A Low-VOC, water-based hard surface polish and protectant containing water, isoparaffinic hydrocarbon, white oil, D-Limonene Trisopropanolomine, and Span 80. The VOC content of this composition is less than or equal to 3.00%. Optionally, a proprietary repellancy treatment component can be added to this composition to increase the composition's hydrophobic and oleophobic capabilities after application to surfaces.

### FIELD OF THE INVENTION

Compositions to polish hard surfaces such as glass, metal, stone, and tile to restore them as closely as possible to a clean condition.

### BACKGROUND OF THE INVENTION

Surfaces, such as those of stone, and certain metal and metal composites, and other hard surfaces such as tile can be polished with liquid compounds. In response to this requirement, a wide range of cleaning compositions already exists in the market.

Generally speaking, commercial compositions are limited both in the range of their effectiveness, and also as to how efficient they really are for their intended purpose. On the consumer market today, for example, there is no known composition which will polish and protect stainless steel and granite. The present invention will polish and protect the following categories of surfaces:

Stainless Steel/Metal Substrates—includes brass, copper, and silver surfaces.

Glass, All Plastics, Lexan®, and Plexiglass®—plastic surfaces, glass composites, window glass, shower doors.

Granite, Marble, Stone, Tile, Ceramics, Formica®—All smooth stone surfaces, ceramic and stone tile, Formica® and artificial countertops.

Wood Surfaces—Smooth wood surfaces, sealed or unsealed.

90% of competing polishes are made with oils and are therefore susceptible to dust and dirt clinging to them. 100% of the competing polished evaporate and very little of the polish is absorbed.

Many existing compositions are objectionable from an environmental standpoint. This composition is water-based, and is environmentally acceptable.

### OBJECTS OF THE INVENTION

It is an object of this invention to provide a water-based environmentally acceptable, biodegradable cleaning/polishing composition which can be used to polish and protect a selection of hard surfaces. These surfaces fall into the above categories of Metal Surfaces, Glass and Plastic, Stone, and Wood.

Any residue of the present compositions which might remain on the surface will not adversely affect the user or the surface to which it was applied. It eliminates the problem of dust collection and fingerprints remaining on the treated surface.

The residue will be hydrophobic and protect the surface from shampoo, soap, body oil, water deposits, fungus, and mold. The present invention can be buffed out using a cloth, but not paper.

The present invention also takes advantage of nano coating technology to fill pores and holes regularly found even in smooth surfaces. Some of the nano coatings are hydrophobic and/or oleophobic. The present compounds will be used to increase the water shedding properties of surfaces after it is applied to those surfaces.

### BRIEF DESCRIPTION OF THE INVENTION

A composition according to this invention specifically designed to polish and protect hard surfaces is water-based and comprises, in addition to water, isoparaffinic hydrocarbon, white oil, D-limonene, Trisopropanolomine, and Span 80. This composition is surprisingly effective for polishing and protecting hard surfaces.

Surfaces to be treated include stainless steel and chrome, granite, marble. and other stones, and window and mirror glass and plastic, and hard woods. It is noted that most modern wood furniture is sealed with a urethane coating, and this invention will work with said coatings.

This formulation represents a paradigm shift away from traditional polishes/protectants. This VOC-compliant formulation works better than non-VOC-formulations in the market, remaining safe for the environment, safe for the individual, and safe for any surface.

A thixotropic agent or a foaming agent can be added to the formula, replacing an equal amount of water. A Proprietary Repellancy Treatment (PRT) that is commercially available can be added to the formula replacing an equal amount of water. Presently, the PRT selected is provided by Fiber Shield and selected from the list of Krystal-Kleer™, Krystal-Kleer+™, Terracryl™, or Watercryl™.

### DETAILED DESCRIPTION OF THE INVENTION

The basic formulation of this invention, itself useful for polishing a wide range of substrate materials is an aqueous solution of water and the chemicals listed below. This solution is biodegradable, low-VOC (less than or equal to 3.0%) and is applicable to a wide range of materials without damaging them. The components of the solution are benign, and if left in place will cause no damage to the substrate to which the solution is applied, or to persons who come in contact with it.

The combination of components used herein appears to function synergistically, by mechanisms which are not fully understood at this time. What has become apparent is that the total composition functions to a degree of effectiveness much greater than already-known compositions useful for the intended purposes, and that elimination of any of the components greatly reduces the effectiveness of the composition.

The are four categories of porosity variance covered by this invention: Metal Surfaces, Glass and Plastic, Stone, and Wood. The invention when applied provided a protection against penetration by water or oil. This effect is improved with the inclusion of the alternate embodiment's third-party proprietary nano coating compound.

As a preliminary observation, it should be noted that purified water (either distilled, de-ionized or softened), is preferred. If it is used, the solution will be clear. If water is used which is not purified, then the solution is likely to be cloudy and sometimes less acceptable to the user. However, some users might actually prefer a cloudy or milky composition. Use of tap water will usually result in this.

The addition in an alternate embodiment of nano coatings amounting to less than 2% of the total formula will confer additional hydrophobic and oleophobic capabilities to the present invention. These coatings are selected as a Proprietary Repellancy Treatment (PRT) from Fiber Shield Krystal-Kleer™, Krystal-Kleer+™, Terracryl™, or Watercryl™.

The presently preferred basic formulation is as follows:

CAS Numbers

| | |
|---|---|
| De-ionized water | 7732-18-5 |
| Isoparaffinic Hydrocarbon | 64742-47-8 |
| White Oil (mineral oil) | 8042-47-5 |
| D-limonene | 5989-27-5 |
| Trisopropanolamine | 122-20-3 |
| silicone 1000 CST | |
| Span 80 | 1338-43-8 |
| Methocel A15C (Methyl cellulose) | 9004-67-5 |
| PRT | Proprietary Formulation |

In all the the formulations and guidelines given below, at least one substance from each group must be included.

The following is the preferred embodiment of the solution, directed towards stainless steel:

| | |
|---|---|
| De-ionized water | 51.25% |
| Isoparaffinic Hydrocarbon | 15-30.0% |
| White Oil (mineral oil) | 10-25.0% |
| D-limonene | 1-5.0% |
| Trisopropanolamine | .5-2.0% |
| silicone 1000 CST | .5-3.0% |
| Span 80 | 1-5.0% |
| Methocel A15C | 0.250 |
| | 100.00% |

An alternate embodiment of the invention, directed towards polishing glass, mirrors, plastic and stone is:

| | |
|---|---|
| De-ionized water | 40-60.0% |
| Isoparaffinic Hydrocarbon | 21-40.0% |
| White Oil (mineral oil) | 10-25.0%% |
| D-limonene | 1-5.0% |
| Trisopropanolamine | .5-2.0% |
| silicone 1000 CST | .5-3.0% |
| Span 80 | 1-5.0% |
| Methocel A15C | 0.250 |
| | 100.00% |

This invention is not to be limited to the embodiments described in the description which are given by way of example and not of limitation, but only in accordance with the scope of the appended claims.

I claim:

1. A water-based composition for polishing and protecting steel, chrome and wood, consisting essentially of:

| | |
|---|---|
| a. De-ionized water | 51.50%; |
| b. Isoparaffinic Hydrocarbon | 15-30.0%; |
| c. White Oil (mineral oil) | 10-25.0%; |
| d. D-limonene | 1-5.0%; |
| e. Trisopropanolamine | .5-2.0%; |
| f. polydimethylsiloxane | .5-3.0%; |
| g. Sorbitane monooleate | 1-5.0%; |

adding up to 100.00% of the composition.

2. A water-based composition for polishing and protecting glass, plastic and stone, consisting essentially of:

| | |
|---|---|
| a. De-ionized water | 60.25%; |
| b. Isoparaffinic Hydrocarbon | 21-40.0%; |
| c. White Oil (mineral oil) | 10-25.0%%; |
| d. D-limonene | 1-5.0%; |
| e. Trisopropanolamine | .5-2.0%; |
| f. polydimethylsiloxane | .5-3.0%; |
| g. Sorbitane monooleate | 1-5.0%; |

adding up to 100.00% of the composition.

3. A water-based composition for polishing and protecting steel, chrome and wood as in claim 1 where the deionized water is replaced with a range of 49.25 to 51.25% deionized water plus a range of 0.50 to 2.00% Proprietary Repellancy Treatment (PRT), the PRT selected from Fiber Shield Krystal-Kleer™, Krystal-Kleer+™, Terracryl™, or Watercryl™.

4. A water-based composition for polishing and protecting glass, plastic and stone, as in claim 2 where the amount of de-ionized water is replaced with a range of 49.25 to 51.25% de-ionized water plus a range of 0.50 to 2.00% PRT, the PRT selected from Fiber Shield Krystal-Kleer™, Krystal-Kleer+™, Terracryl™, or Watercryl™.
